(19) United States
(12) Patent Application Publication
(10) Pub. No.: US 2018/0272160 A1
(43) Pub. Date: Sep. 27, 2018

(54) COMPACT FIRE RESCUE MAT AND HARNESSES

(71) Applicant: Michael S. Wielgat, Chicago, IL (US)

(72) Inventor: Michael S. Wielgat, Chicago, IL (US)

(21) Appl. No.: 15/927,557

(22) Filed: Mar. 21, 2018

Related U.S. Application Data
(60) Provisional application No. 62/474,325, filed on Mar. 21, 2017.
(60) Provisional application No. 62/490,272, filed on Apr. 26, 2017.

(51) Int. Cl. A62B 5/00; A62B 1/02; A61G 1/04

(52) U.S. Cl. CPC A62B 5/00; A61G 1/04; A62B 1/02

(57) ABSTRACT

A fire rescue mat has an outer skin and a plurality of support members. The outer skin is produced from a flexible material and forms a plurality of pockets arranged in columns and rows. The support members located within the pockets. Linear fold lines separate each pocket from an adjacent pocket. The fire rescue mat can be folded along the fold lines to reduce an overall size of the fire rescue mat apparatus.

### CROSS-REFERENCE TO RELATED APPLICATIONS

This Application claims priority to and the benefit of U.S. Provisional Application No. 62/474,325, filed Mar. 21, 2017, and U.S. Provisional Application No. 62/490,272, filed Apr. 26, 2017. The entire contents of each provisional application is hereby incorporated by reference as if fully set forth herein.

### FEDERALLY SPONSORED RESEARCH OR DEVELOPMENT

N/A

### TECHNICAL FIELD

The invention relates to fire rescue equipment; more particularly, the invention relates to a compact, foldable fire rescue stretcher and harness.

### BACKGROUND

Rescue personnel are often called upon to remove unconscious or injured victims in hostile environments, for example during a fire. Moving these victims typically requires the use of a stretcher, backboard, or the like. These items are generally very bulky and difficult to use and often require retrieval from outside the burning structure. The present invention is designed to overcome these issues.

Additionally, firefighters must often move or drag firehoses. These hoses can be quite heavy and difficult to move. The present invention is also designed to provide an aid to moving heavy firehoses and the like.

### SUMMARY

One aspect of the invention is directed to a fire rescue mat apparatus. The apparatus comprises an outer skin of flexible material, linear fold lines, and a plurality of support members. The linear fold lines define a plurality of zones arranged in columns and rows, wherein the fire rescue mat apparatus can be folded along the fold lines to reduce an overall size of the fire rescue mat apparatus. Each of the plurality of support members is located within a corresponding zone.

Another aspect of the invention is directed to a fire rescue mat apparatus. The apparatus comprises an outer skin of flexible material forming a plurality of pockets arranged in columns and rows, a plurality of support members located within the pockets, and linear fold lines. The linear fold lines separate each pocket from an adjacent pocket, wherein the fire rescue mat apparatus can be folded along the fold lines to reduce an overall size of the fire rescue mat apparatus.

Another aspect of the invention is directed to a fire rescue mat apparatus. The apparatus comprises an outer skin of flexible material, a plurality of support members, linear fold lines, handles, strapping, a lifting ring, and retainers. The outer skin is chosen from a group consisting of a high-density polyethylene, a meta aramid, a cotton, a wool, a fiberglass, and a para-aramid. The outer skin forms a plurality of pockets arranged in columns and rows. A pair of adjacent center columns comprises four rows of equal-sized rectangular pockets. Wing columns are located on opposing sides of the adjacent center columns such that the adjacent center columns are located between the wing columns. Each wing column comprises a pair of rectangular pockets having a size substantially equal to the equal-sized pockets of the adjacent center column. Smaller pockets have a right trapezoidal shape and are located on opposing sides of the pair of rectangular pockets, wherein the right trapezoidal pockets are located at corners of the rescue apparatus, wherein the fire rescue mat apparatus has an octagonal shape, wherein a pair of first parallel edges is separated from a pair of parallel second edges by angled edges formed by the right trapezoidal pockets, wherein a length of the outer skin is greater than a width of the outer skin. The support members are located within the pockets. and are at least semi-rigid. The support members are produced from a polymeric material. The support members comprise twelve equal-sized plates located within twelve rectangular pockets formed by the outer skin and four equal-sized smaller plates located within the right trapezoidal pockets formed by the outer skin. The twelve-equal-sized plates and the four equal-sized small plates have a rectangular shape. The linear fold lines separate each pocket from an adjacent pocket, wherein the fire rescue mat apparatus can be folded along the fold lines to reduce an overall size of the fire rescue mat apparatus. Each fold line comprises a seam delimiting each pocket. The seam is formed by joining opposite surfaces of the outer skin together by an attachment chosen from the group consisting of sewing, welding, hook and loop, rings, and spiral binding, wherein the fire rescue mat apparatus fits within a standard thigh pocket of a standard pair of turnout pants. The handles are formed along opposing lengthwise sides of the rescue apparatus formed by apertures in the wing columns. The strapping is attached to the outer skin for securing a victim to the rescue apparatus. The lifting ring is located along one of the sides of the rescue apparatus and is attached to the outer skin. The retainer is attachable to the rescue apparatus when in the fully folded condition and is configured to maintain the rescue apparatus in the fully folded condition. The outer skin forms a mat in a fully unfolded condition on which a victim can be positioned and retained thereto by the strapping. The outer skin has an engagement surface comprising a friction reducing material. The fire rescue mat apparatus qualifies as a Class 2 rescue harness. At least some of the pockets have a fluid-tight seal and wherein the at least some of the pockets can be inflated. The wing columns can be wrapped around a victim to form a protective shield substantially about a torso of the victim by tightening the strapping.

Another aspect of the invention is directed to a firehose sling. The firehose sling comprises a sling retainer configured to attach to a tubular-shaped firehose and a sling attached to the sling retainer and extendable therefrom.

Another aspect of the invention is directed to a firehose sling. A unibody sling retainer is formed from a swatch of a woven fabric and configured to wrap circumferentially about a tubular-shaped firehose. A main body of the unibody sling has a rectangular shape and a top surface and a bottom surface. A pocket is formed by folding a first portion of the main body over a second portion of the main portion and is maintained in position by a first hook and loop fastener sewn to an edge of the top surface of the main body in engagement with a second hook and loop fastener sewn to the top surface of the main body. A flap is formed by a folding of a third portion of the main body over the pocket to close the pocket by a third hook and loop fastener sewn to the edge of the top surface in engagement with a fourth hook and loop fastener on the bottom surface of the first portion of the main body. A slotted aperture is located between the second portion of the main body and the third portion of the main body. A tongue is parallel to a length of the slotted aperture and has a substantially rectangular shape integral with and extending outwardly from the main body and has a length substantially equal to a length of a first side of the main body substantially parallel to the tongue. The tongue intersects a second side of the main body transverse to the first side and shares a portion of the second side. A top surface of the tongue is conterminous with the top surface of the main body and has a nonslip surface configured to engage an outer skin of a tubular-shaped firehose when the sling retainer is wrapped circumferentially about a firehose. A bottom surface of the tongue is conterminous with the bottom surface of the main body. The bottom surface has a fifth hook and loop fastener sewn thereon configured to fasten to a complimentary sixth hook and loop fastener on the bottom side of the main body. A sling is extendable from the pocket in the sling retainer and has a U-shape. Ends of the sling are sewn to the top surface of the main body within the pocket. An intermediate section of the sling comprises a pair of sets of accordion folds beginning at each of the pair of ends and moving outwardly towards a center portion of the sling. The center portion has a seventh hook and loop fastener attaching it to an eighth hook and loop fastener on the top surface of the main body on the flap adjacent the slotted aperture such that the folding of the third portion of the main body to produce the flap causes the center portion having a color-alert attached thereto to reside within the slotted aperture and to be visible on the bottom surface of the main body through the slotted aperture. The pair of sets of accordion folds is stored within the pocket. A pull tab is sewn to the center portion and extends outwardly from the slotted aperture in the main body with the center portion. The firehose sling is configured to wrap around and attach to a segment of firehose by placing the segment of firehose against the non-slip surface at a terminal end of the tongue opposite a connection of the tongue with the main body and wrapping the tongue about a circumference of the segment of firehose to cause the fifth hook and loop fastener on the bottom surface of the tongue to engage the sixth hook and loop fastener on the bottom surface of the main body. The firehose sling forms a circumferential sleeve on the segment of firehose with the slotted aperture located at a first end of the circumferential sleeve oriented transverse to a length of the segment of firehose. The tab extends from the slotted aperture parallel to the length of the segment of firehose against the circumferential sleeve from the first end of the circumferential sleeve towards a second end of the circumferential sleeve opposite the first end of the circumferential sleeve.

### BRIEF DESCRIPTION OF THE DRAWINGS

To understand the present invention, it will now be described by way of example, with reference to the accompanying drawings in which:

FIG. 1 is a top view of an embodiment of the invention;

FIG. 2 is a side view of the embodiment of FIG. 1 in a partially folded condition rotated 90 degrees about an axis passing through the length of the invention with the strapping removed for clarity;

FIG. 3 is the view of the invention as shown in FIG. 2 in a fully folded condition;

FIG. 4 is the invention in a fully folded condition as shown in FIG. 3 and rotated 90 degrees clockwise;

FIG. 5 is a top view of an embodiment of the invention with the strapping removed for clarity;

FIG. 6 is a cross-section of the embodiment shown in FIG. 5;

FIG. 7 is the embodiment shown in FIG. 5 in a partially folded condition;

FIG. 8 is the embodiment shown in FIG. 5 in a partially folded condition;

FIG. 9 is the embodiment shown in FIG. 5 in a partially folded condition with retainers attached to maintain the invention in the folded condition;

FIG. 10 is a side view of an embodiment of the invention in a fully folded condition;

FIG. 11 is a top view of the embodiment illustrated in FIG. 10 in a first partially unfolded condition;

FIG. 12 is a view of the embodiment illustrated in FIG. 10 in a third partially unfolded condition;

FIG. 13 is a second view of the embodiment illustrated in FIG. 10 in the third partially unfolded condition;

FIG. 14 is a view of an embodiment in a fully unfolded condition;

FIG. 14A is a top view of the embodiment of FIG. 14;

FIG. 15 is a view of the embodiment illustrated in FIG. 10 with a body retained to the base mat;

FIG. 16 is a view of the embodiment illustrated in FIG. 10 with a body retained to the base mat;

FIG. 17 is a view of a pair of turnout pants showing a hip pocket into which the embodiments of the invention can be inserted;

FIG. 18 is a top view of the embodiment illustrated in FIG. 10 in a first partially unfolded condition;

FIG. 19 is a top view of an embodiment of the invention;

FIG. 20 is a cross-section of the embodiment shown in FIG. 19;

FIG. 21 is the embodiment shown in FIG. 19 in a partially folded condition;

FIG. 22 is the embodiment shown in FIG. 19 in a partially folded condition

FIG. 23 is a side view of the embodiment of FIG. 19 in a partially folded condition rotated 90 degrees clockwise and rotated 90 degrees about an axis passing through a center of the mat of the invention with the strapping removed for clarity;

FIG. 24 is the view of the invention as shown in FIG. 19 in a fully folded condition;

FIG. 25 is a cross-section taken through the fully folded condition shown in FIG. 24 and enlarged for clarity;

FIG. 26 is an embodiment of the invention showing inflatable pockets and air canisters provided for inflating same;

FIG. 27 is a top view of an embodiment of the invention wrapped around a cylindrical hose;

FIG. 28 is a bottom view of an embodiment of the invention wrapped around a cylindrical hose;

FIG. 29 is a side view of an embodiment of the invention wrapped around a cross-section of a segment of a cylindrical hose;

FIG. 30 is a side view of an embodiment of the invention wrapped around a cross-section of a segment of a cylindrical hose;

FIG. 31 is a top view of an embodiment of the invention with an extendable sling fully extended from a sling retainer;

FIG. 32 is a top view of an embodiment of the invention with a sling retainer in a fully open condition and an extendable sling partially extended through a slotted aperture in the sling retainer;

FIG. 33 is a top view of an embodiment of the invention with a sling retainer in a fully open condition and an extendable sling fully retracted;

FIG. 34 is a top view of an embodiment of the invention with a sling retainer in a partially open condition and an extendable sling fully retracted within the sling retainer;

FIG. 35 is a top view of an embodiment of the invention with a sling retainer in a fully closed condition and an extendable sling fully retracted such that a grab portion of the sling is accessible through a slotted aperture in the sling retainer;

FIG. 36 is a bottom view of the embodiment of FIG. 35;

FIG. 37 is a top view of the embodiment of FIG. 35 in the process of being attached to a segment of a firehose; and

FIGS. 38-41 are a series of figures showing an embodiment of the invention as an extendable sling is extended from a sling retainer attached to a firehose.

### DETAILED DESCRIPTION

While this invention is susceptible of embodiments in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

### Compact Fire Rescue Mat and Harness

Referring to the figures, embodiments of a fire rescue device 10 comprise a foldable unit or mat 14. Each embodiment primarily includes a plurality of semi-rigid panels sewn into a flexible cloth or cloth-like material such as canvas, Nomex, Kevlar, or the like. The mat folds into a size small enough to fit in the pocket of standard firefighter pants called turnout pants. Each panel may be sewn into a separate compartment such that the mat folds along seams between adjacent panels. In certain embodiments, the mats have eight equally sized center panels arranged in two columns of four. Opposing wing columns each consist of two additional panels of equal size to the center panels and two smaller roughly half-sized panels at the top and bottom of the wing columns. Holes/handles may be included in the wing columns.

The mat 14 includes an outer skin 18 of a flexible material. Flexible as used herein is used to indicate a material that can be readily folded and unfolded many times without undergoing plastic or permanent deformation. The flexible material is preferably chosen from a group consisting of a high-density polyethylene, a meta aramid, a cotton, a wool, a fiberglass, and a para-aramid. The outer surface may have a dragging or an engagement surface 22 comprising a friction reducing material, such as a polymeric material, e.g. plastic, or a specialized coating, e.g. a Teflon coating or the like, to facilitate dragging of a victim secured to an opposite surface of the mat.

The outer skin 18 forms a plurality of pockets arranged in columns and rows. A pair of adjacent center columns 32, 36 comprises four rows of equally-sized rectangular pockets 42. These pockets 42 are preferably equally sized, but can be varied as deemed necessary to provide the necessary function of foldability.

Wing columns 38, 40 are located on opposing sides of the adjacent center columns 32, 36 such that the adjacent center columns 32, 36 are located between the wing columns 38, 40. Each wing column 38, 40 comprises a pair of rectangular pockets having a size substantially equal to the pockets 42 of the adjacent center column. Each wing has two smaller pockets 44 which take the shape of a right trapezoid. These smaller pockets 44 are located on opposing sides of the pair of rectangular pockets wherein the right trapezoidal pockets 44 are located at corners of the rescue mat 14. This arrangement forms an octagonal shape. The octagonal shape includes a pair of first parallel edges separated from a pair of parallel second edges by angled edges formed by the right trapezoidal pockets 44. A length of the outer skin 18 is greater than a width of the outer skin 18.

Support members are located within the pockets. The support members are at least semi-rigid and may be produced from a polymeric material or a carbon-fiber material in the form of thin plates. Preferably, the support members comprise twelve equal-sized plates 48 located within twelve rectangular pockets formed by the outer skin 18 and four equal-sized smaller plates 52 located within the right trapezoidal pockets 44 formed by the outer skin 18. The twelve-equal-sized plates 48 and the four equal-sized small plates 52 have a rectangular shape.

Again, the plates 48 are preferably equally-sized. However, the size requirement of the plates can be varied in order to accomplish or achieve the necessary function of foldability of the mat 14.

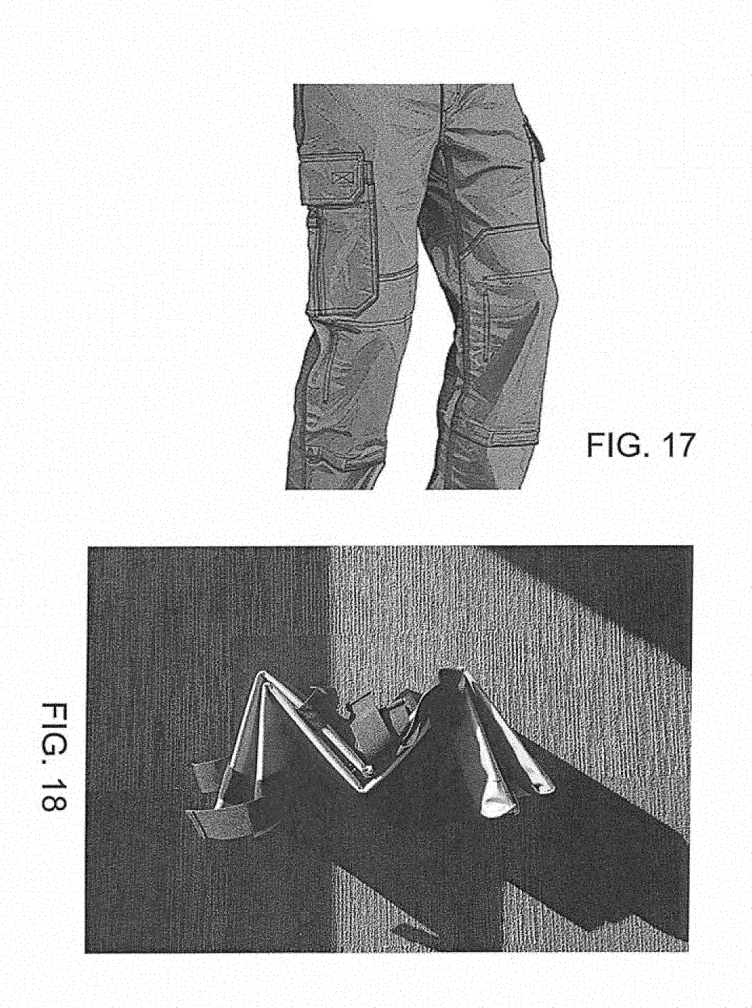

Linear fold lines 56 separate pockets from adjacent pockets. The fire rescue mat 14 can be folded along these fold lines 56 according to the direction of arrows indicated in the figures to reduce an overall size of the fire rescues mat 14. Each fold line 56 comprises a seam delimiting each pocket. The seams are formed by joining opposite surfaces of the outer skin 18 by an attachment. Examples of suitable attachments include sewing, welding, hook and loop, rings, and spiral binding. The mat 14 is preferably foldable such that it fits within a standard thigh pocket of a standard pair firefighter's trousers (see FIG. 17). A width of the fold lines (i.e. spacing between the pockets) can altered or variable as necessary to promote the desired folding result.

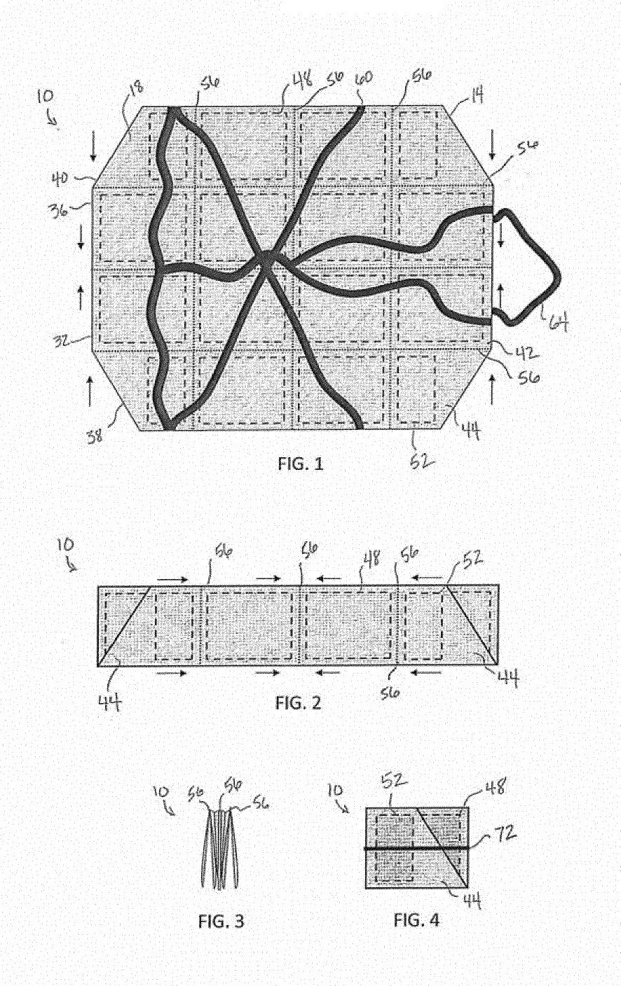

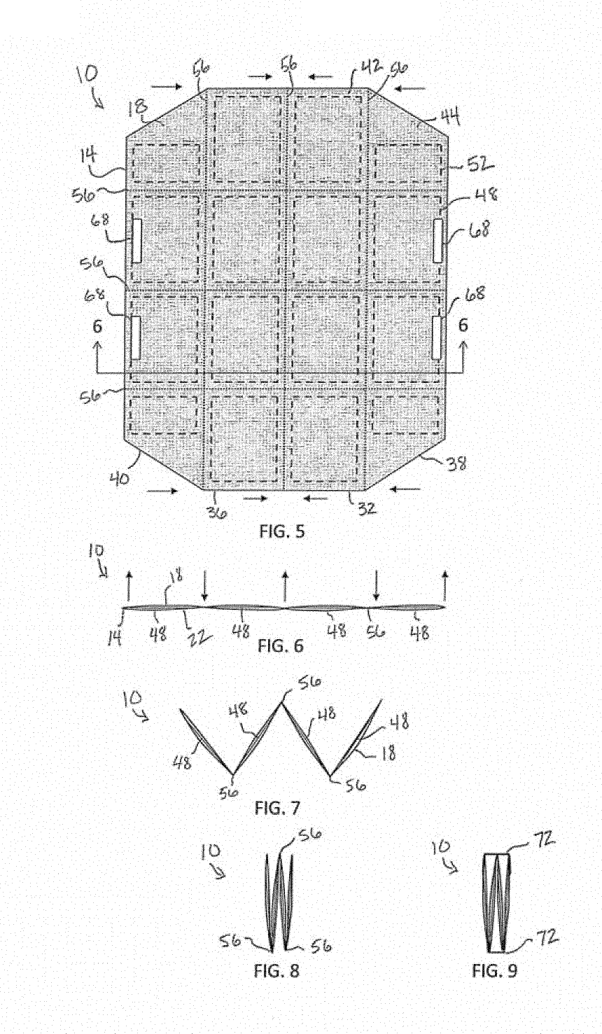

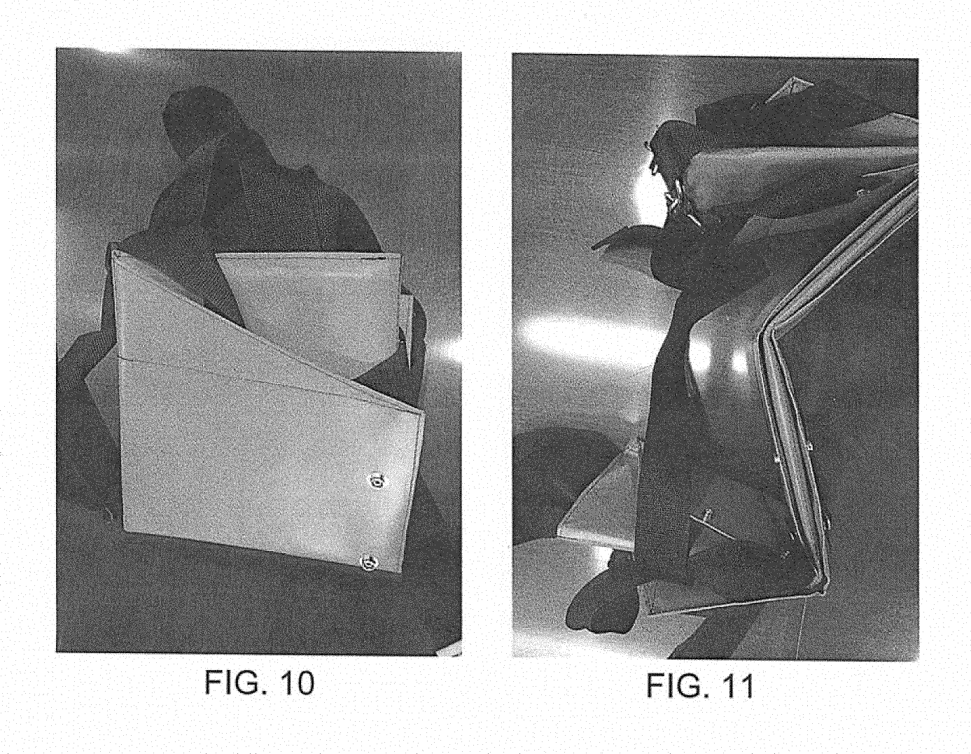

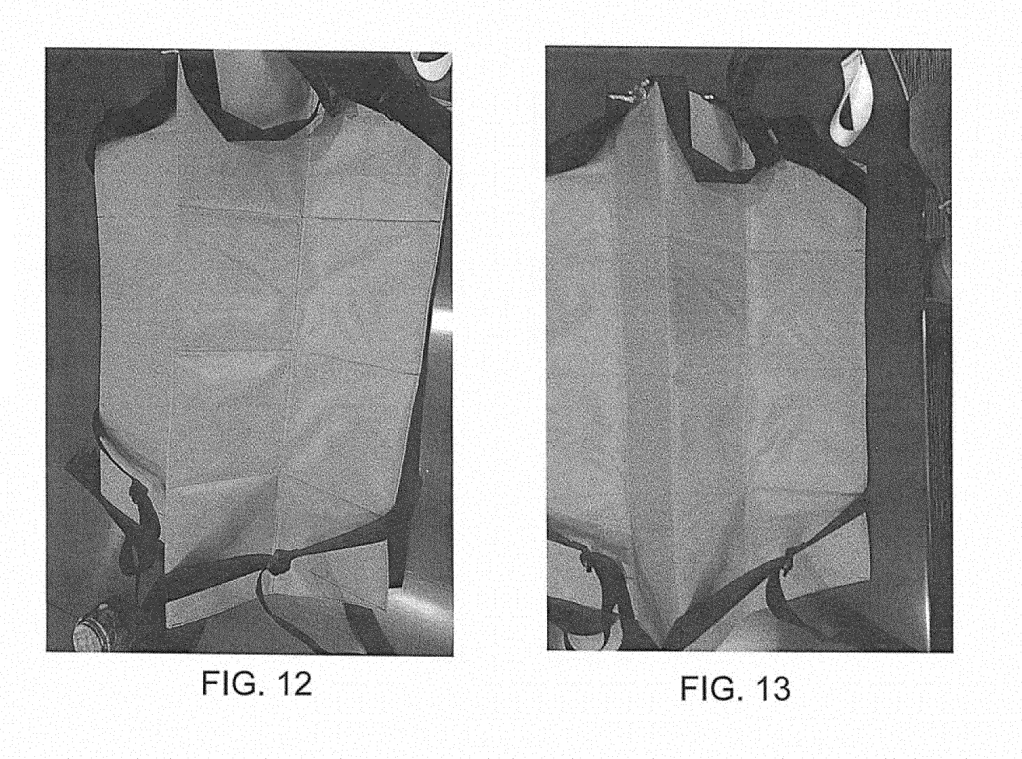

As shown in FIG. 1, the mat 14 includes strapping 60 that forms a harness for securing and retaining a victim to the mat. The strapping 60 is attached to the outer skin 18 of the mat 14 and may include buckles, snaps, carabiners and the like for attaching ends of the strapping together, varying the length of the strapping, and for ease of use. The strapping 60 may have an elastic quality to secure the victim to the mat 14. The wing columns 38, 40 can be wrapped around a victim to form a protective shield substantially about a torso of the victim by tightening the strapping to cocoon the victim by wrapping the mat 14 about the victim.

As shown in FIG. 1, a lifting ring 64 is located along one of the sides of the rescue mat. The lifting ring 64 is generally located along an edge of the mat 14 configured for the victim's head. The lifting ring may be produced from strapping material similar to the harness material. It is securely fastened to outer skin 18 and/or the support members wherein a lifting ring can be used to drag the mat 14 with a victim secured thereto and lift a victim attached to the unit that is down in a hole such that the victim and the mat 14 can be hoisted by pulling the lifting ring. Alternatively, the lifting ring 64 can be produced from a rigid material, such as a metal or hard plastic.

Handles 68 may be formed along opposing lengthwise sides of the rescue mat (see, e.g., FIG. 5). The handles 68 can be formed by additional strapping. However, the handles are preferably formed by apertures in the wing columns.

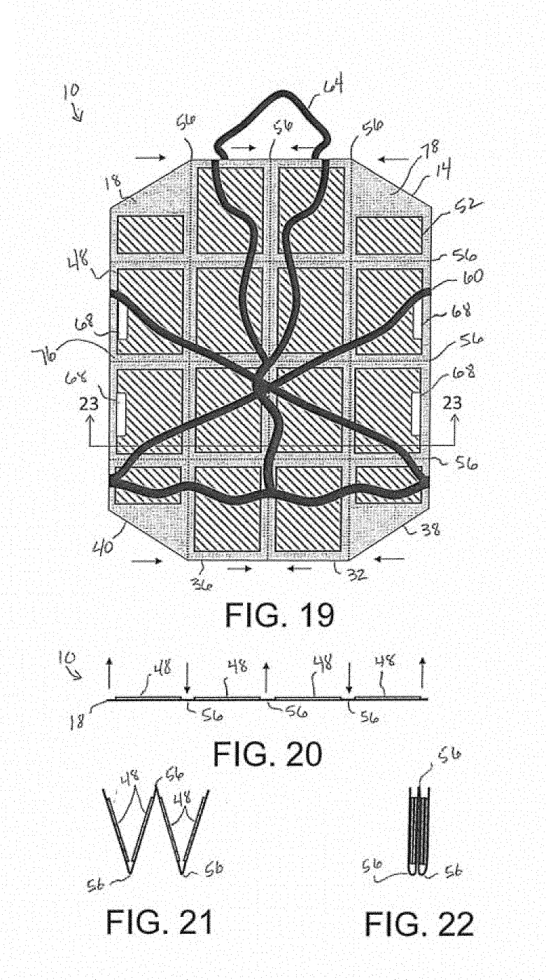

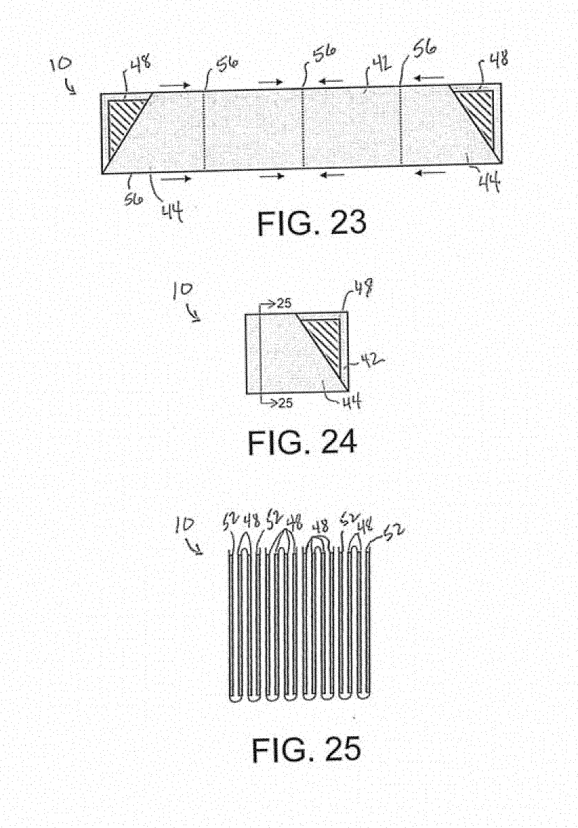

Referring to FIGS. 19-25, the fire rescue mat apparatus 10 comprises an outer skin 18 of the flexible material, linear fold lines 56, and a plurality of support members 48, 52. Here, the support members 48, 52 are secured to an upper surface of the outer skin 18 within zones 76 delimited by the fold lines 56.

The linear fold lines 56 define a plurality of zones arranged in columns and rows. Again, the fire rescue mat apparatus 10 can be folded along the fold lines 56 to reduce an overall size of the fire rescue mat apparatus 10. The zones are similar in area to the area of the pockets of the previous embodiment.

The size, placement, and location of the support members in this embodiment are similar in this embodiment, except for the fact that the support members are not secured within pockets. Rather, here, the support members have an exposed surface and an opposite surface attached to the upper surface of the outer skin 18.

One embodiment includes a retainer 72. The retainer 72 is attachable to the rescue mat 14 when in the fully folded condition and is configured to maintain the rescue apparatus in the fully folded condition. It may be attached via hook and loop, snaps, buckles, carabiners, or any suitable variation or substitute thereof.

In one embodiment, the fire rescue mat 14 qualifies as a Class 2 rescue harness. A Class 2 Chest harness is used when there are only limited fall hazards (no vertical free fall hazard), or for retrieving persons such as removal of persons from a tank or a bin. In this embodiment, leg or groin straps are included as depicted in the figures.

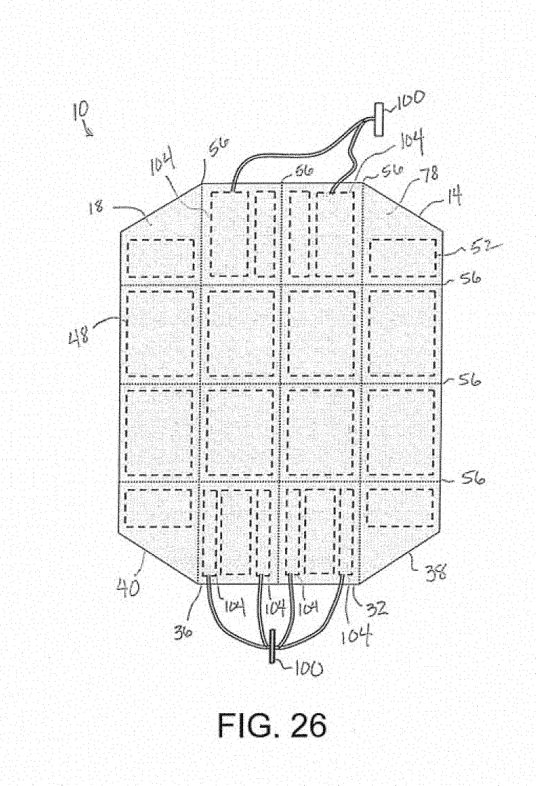

In one embodiment, air cylinders 100 under pressure can be activated to support or immobilize the victim's spine or cervical areas. Here, at least some of the pockets 104 have a fluid-tight seal and wherein these pockets 104 can be inflated. Air cylinder 100 could also be activated to promote circulation from extremities to the victim's torso. This can redirect blood flow from extremities to the torso. (See FIG. 26).

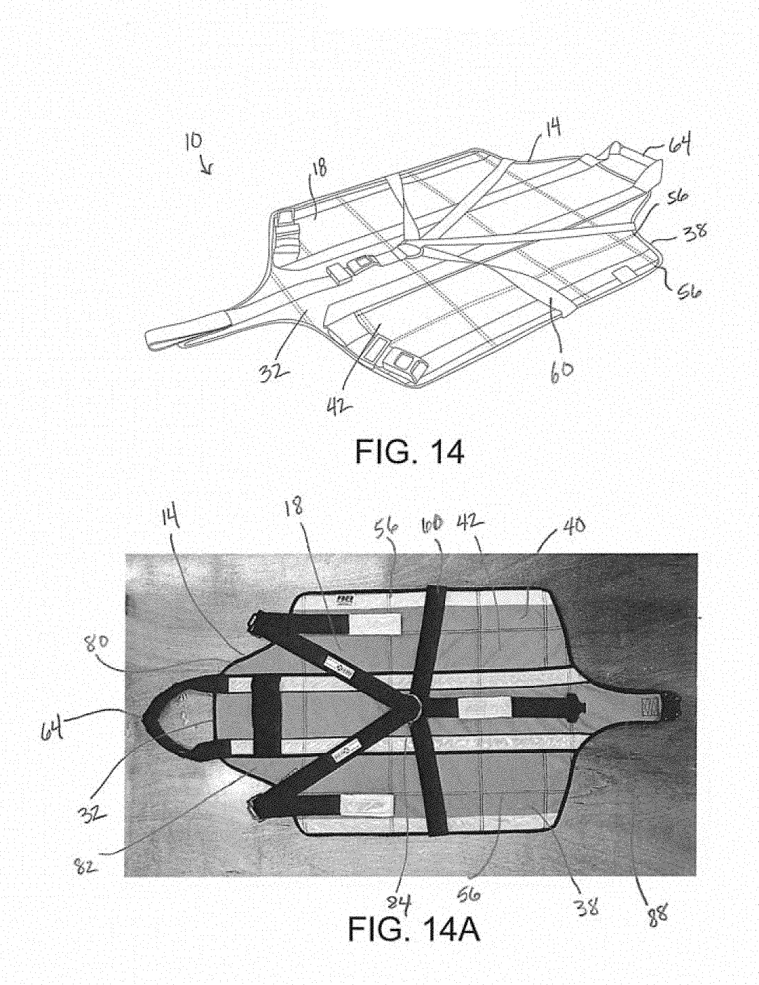

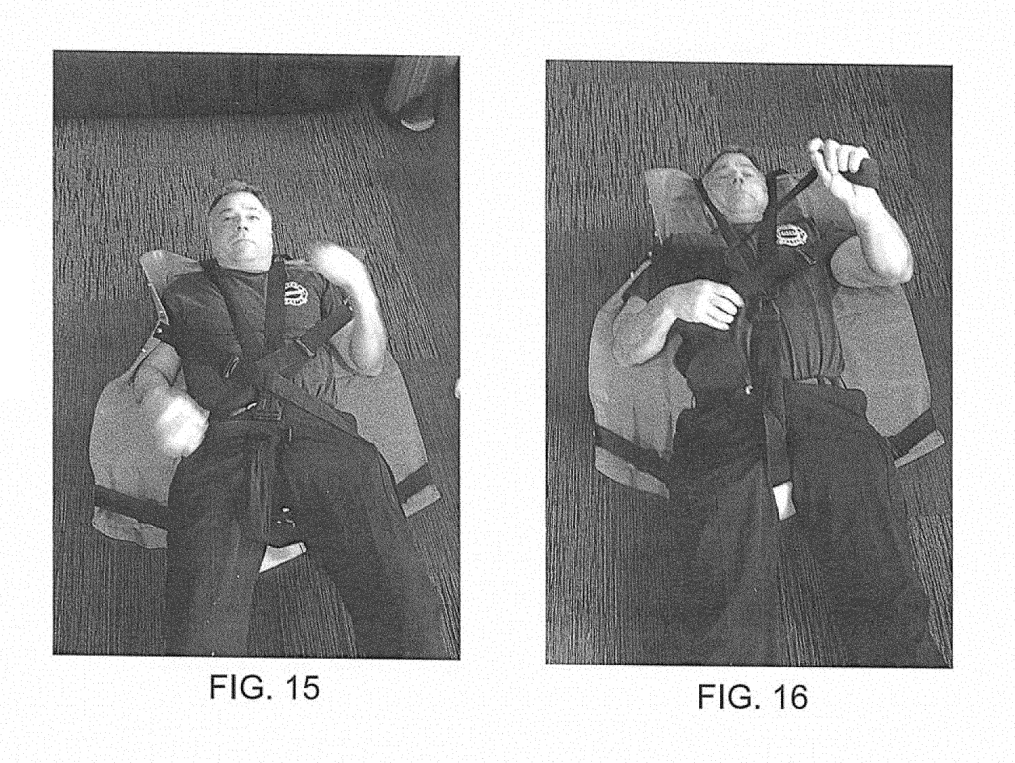

Referring specifically to FIGS. 14 and 14A, one embodiment of the rescue mat 14 comprises a single center column 32. A pair of lateral columns 80, 82 are located between the center column 32 and the wing columns 38, 40. Each of the columns are outfitted with the pockets 42 described above, although the pockets here may be sized appropriately for their respective locations within the rescue mat 14. A separate retainer 84, such as a ring, carabiner, or the like, gathers the strapping 60 at an intersection point within a boundary of the center column 32. A crotch tab 88 extends outwardly from the center column 32 and is configured to be located between a victim's legs. This crotch tab 88 can be used by a second firefighter to aid transport of a victim.

### Alternative Embodiments of the Rescue Mat

A fire rescue mat apparatus comprising:

an outer skin of flexible material forming a plurality of pockets arranged in columns and rows;

a plurality of support members located within the pockets;

linear fold lines separating each pocket from an adjacent pocket, wherein the fire rescue mat apparatus can be folded along the fold lines to reduce an overall size of the fire rescue mat apparatus.

A fire rescue mat apparatus wherein the flexible material is chosen from a group consisting of a high-density polyethylene, a meta aramid, a cotton, a wool, a fiberglass, and a para-aramid.

A fire rescue mat apparatus wherein a pair of adjacent center columns comprises four rows of equal-sized rectangular pockets.

A fire rescue mat apparatus wherein wing columns are located on opposing sides of the adjacent center columns such that the adjacent center columns are located between the wing columns.

A fire rescue mat apparatus wherein each wing column comprises a pair of rectangular pockets having a size substantially equal to the equal-sized pockets of the adjacent center column.

A fire rescue mat apparatus wherein smaller pockets having a right trapezoidal shape are located on opposing sides of the pair of rectangular pockets.

A fire rescue mat apparatus wherein the right trapezoidal pockets are located at corners of the rescue apparatus.

A fire rescue mat apparatus wherein the fire rescue mat apparatus has an octagonal shape.

A fire rescue mat apparatus wherein a pair of first parallel edges is separated from a pair of parallel second edges by angled edges formed by the right trapezoidal pockets.

A fire rescue mat apparatus of wherein the plurality of support members comprises twelve equal-sized plates located within twelve rectangular pockets formed by the outer skin and four equal-sized smaller plates located within the right trapezoidal pockets formed by the outer skin, the twelve-equal-sized plates and the four equal-sized small plates have a rectangular shape.

A fire rescue mat apparatus wherein each fold line comprises a seam delimiting each pocket.

A fire rescue mat apparatus wherein a seam is formed by joining opposite surfaces of the outer skin together by an attachment.

A fire rescue mat apparatus wherein the attachment is chosen from the group consisting of sewing, welding, hook and loop, rings, and spiral binding.

A fire rescue mat apparatus further comprising handles formed along opposing lengthwise sides of the rescue apparatus formed by apertures in the wing columns;

A fire rescue mat apparatus further comprising strapping attached to the outer skin for securing a victim to the rescue apparatus.

A fire rescue mat apparatus further comprising a lifting ring along one of a side of the rescue apparatus and attached to the outer skin;

A fire rescue mat apparatus further comprising a retainer attachable to the rescue apparatus when in the fully folded condition configured to maintain the rescue apparatus in the fully folded condition.

A fire rescue mat apparatus wherein at least some of the pockets have a fluid-tight seal and wherein the at least some of the pockets can be inflated.

A fire rescue mat apparatus of any preceding embodiment wherein the outer skin forms a mat in a fully unfolded condition on which a victim can be positioned and attached thereto by a strapping.

A fire rescue mat apparatus of any preceding embodiment wherein the outer skin has an engagement surface comprising a friction reducing material.

A fire rescue mat apparatus of any preceding embodiment wherein the fire rescue mat apparatus qualifies as a Class 2 rescue harness comprising groin straps.

A fire rescue mat apparatus of any preceding embodiment wherein the fire rescue mat apparatus fits within a standard thigh pocket of a standard pair turnout pants.

A fire rescue mat apparatus of any preceding embodiment wherein a length of the outer skin is greater than a width of the outer skin.

A fire rescue mat apparatus of any preceding embodiment wherein the support members are at least semi-rigid.

A fire rescue mat apparatus of any preceding embodiment wherein the support members are produced from a polymeric material.

### Extendable Firehose Sling

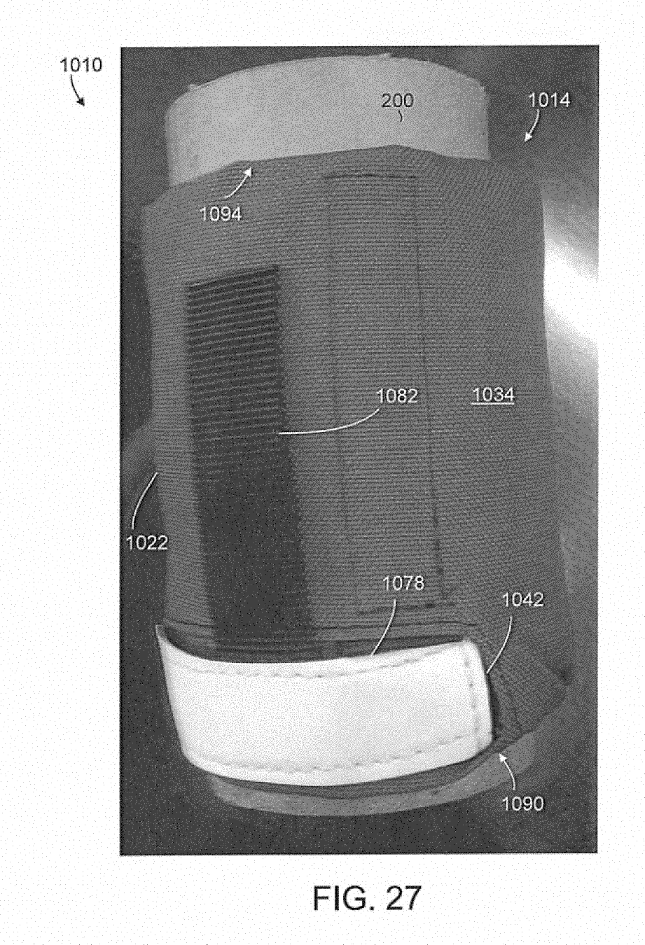

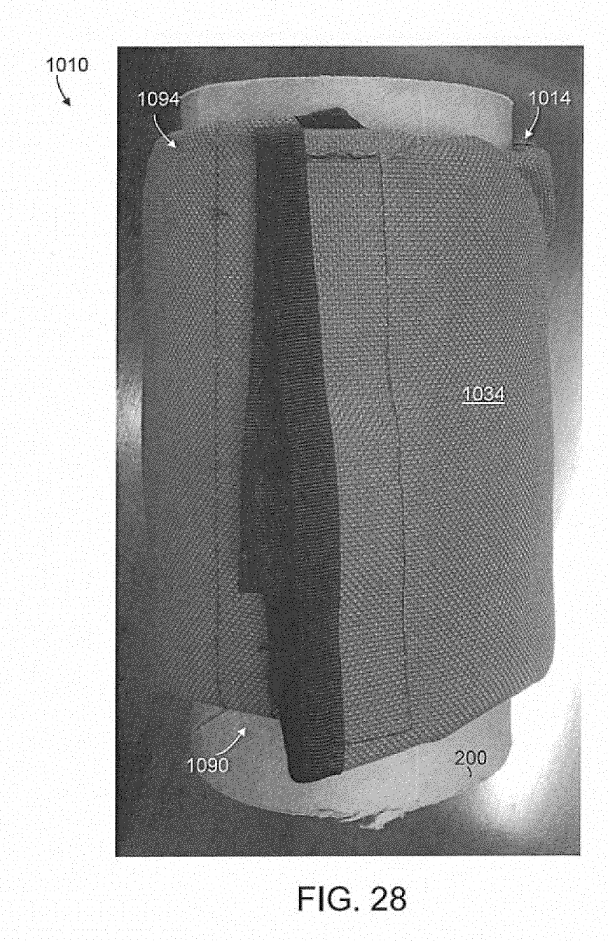

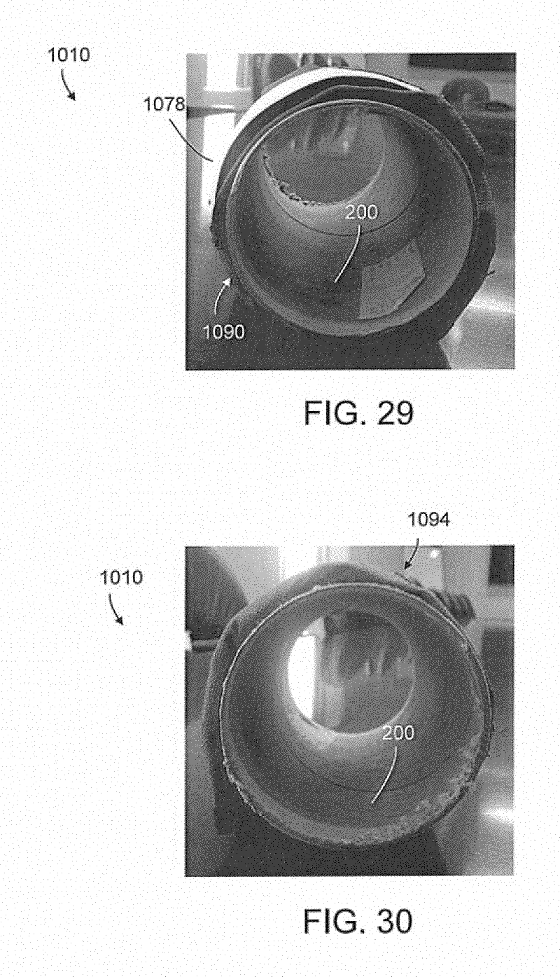

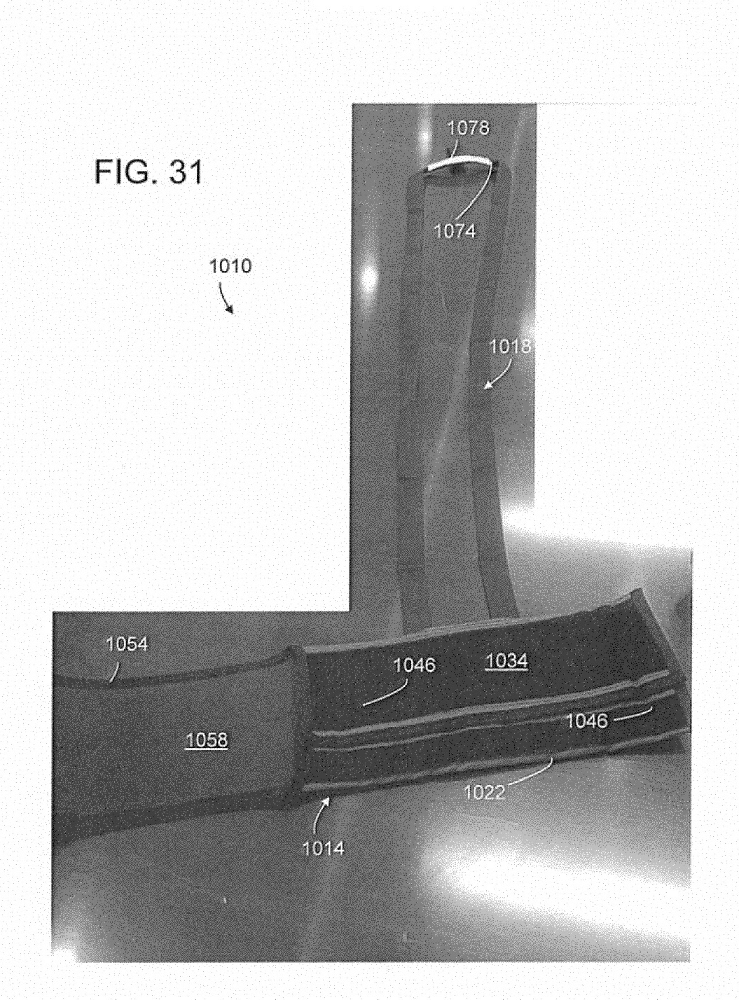

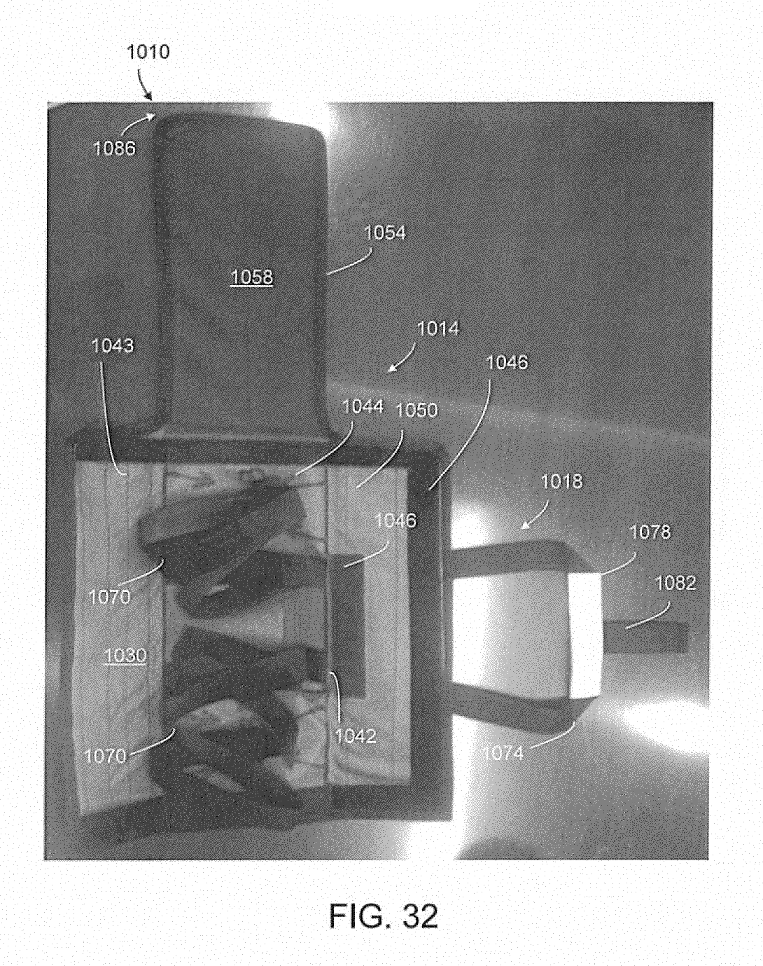

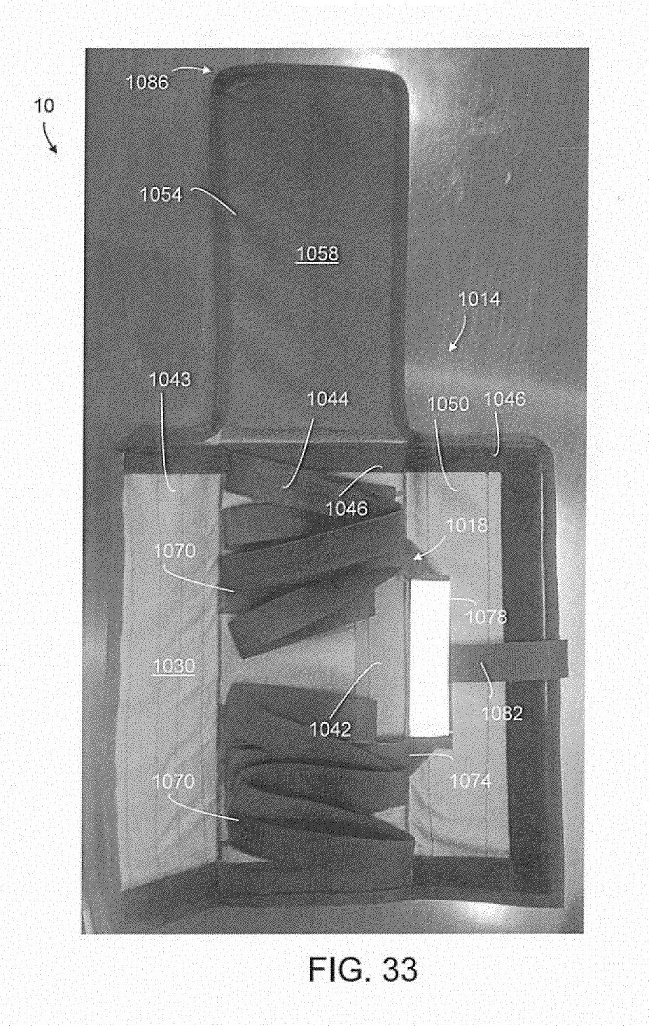

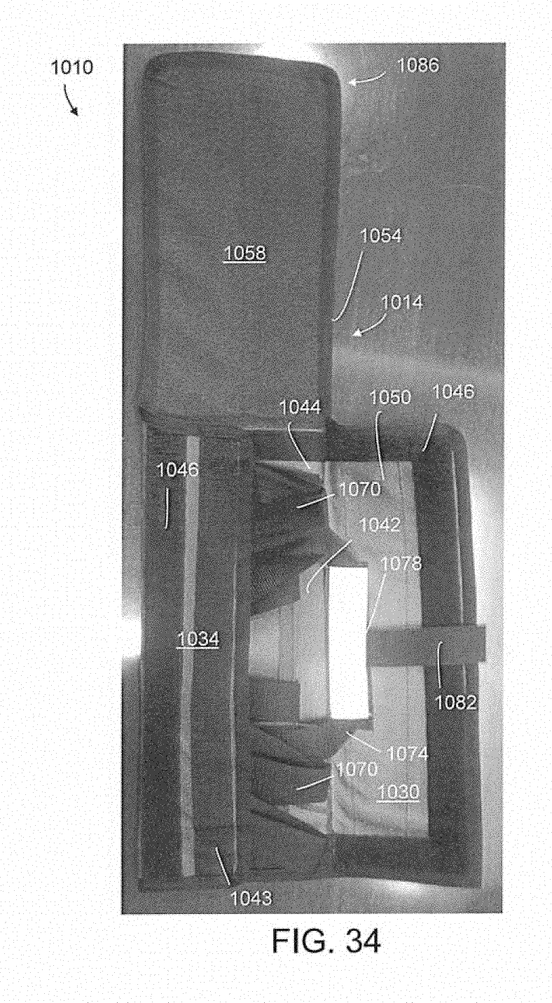

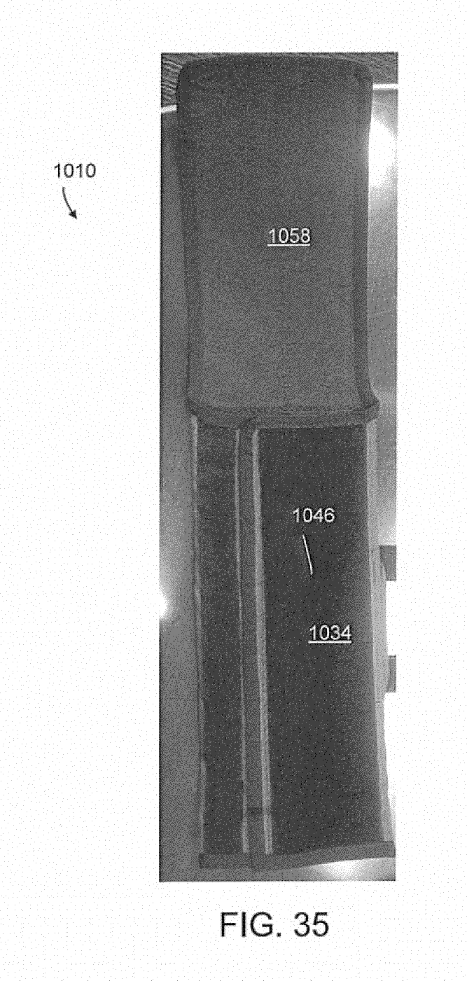

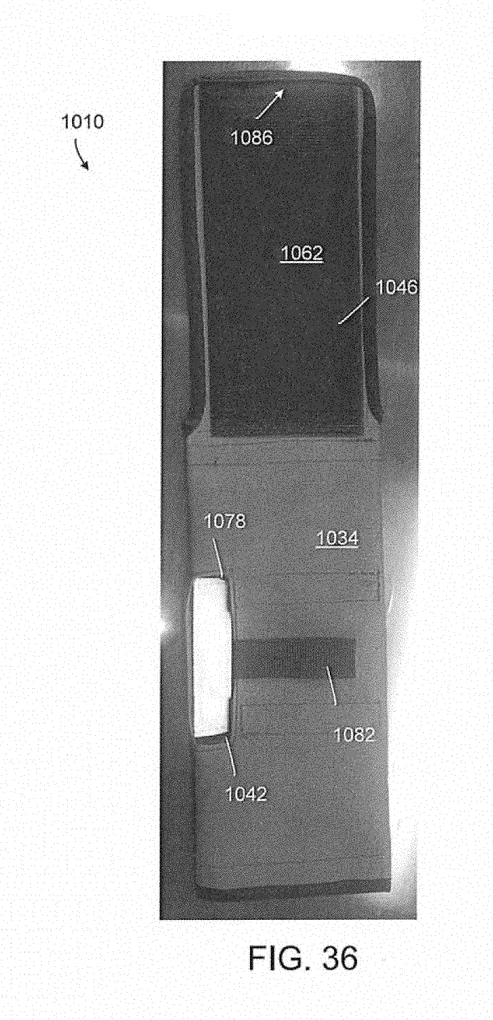

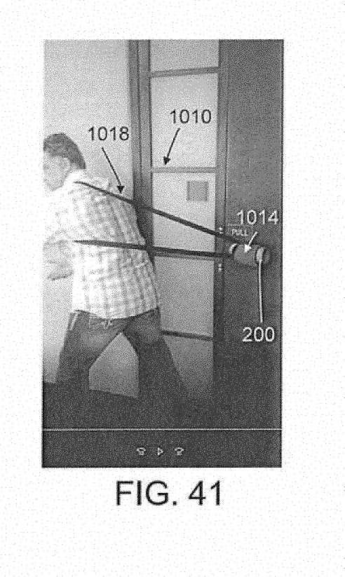

FIGS. 27-41 show a firehose sling 1010 of the present invention. The firehose sling 1010 comprises a retainer 1014 and a sling 1018 which is extendable from the retainer 1014.

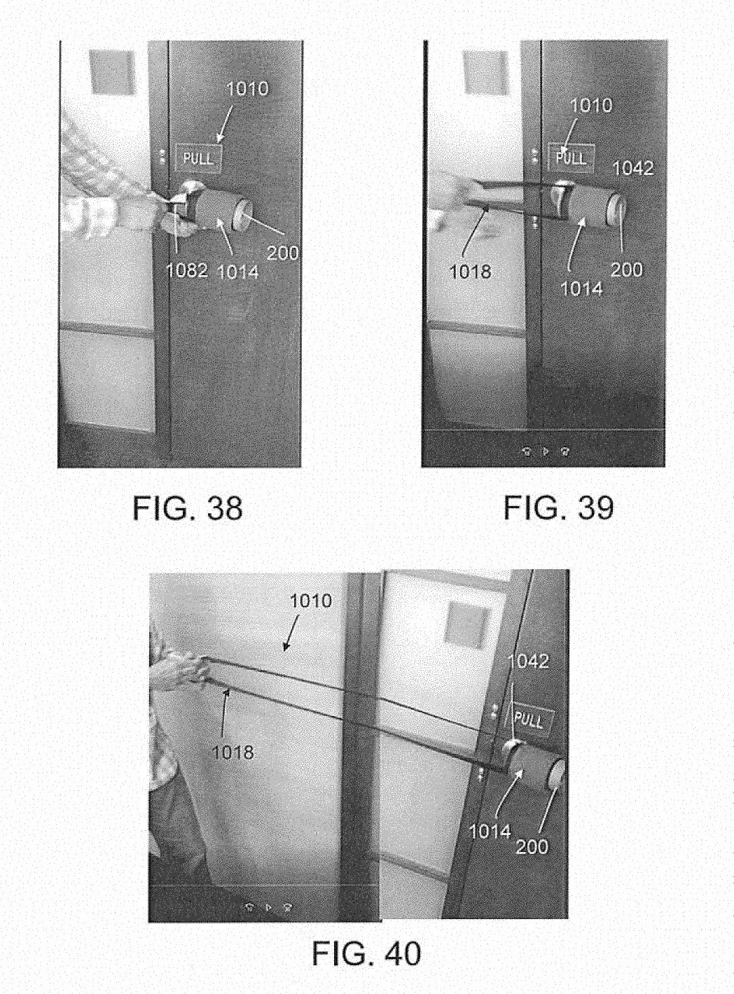

As shown in FIGS. 38-41, in use, one or more firehose slings 1010 are attached to a segment of a firehose 200. In the figures, the firehose 200 is simulated by a short cylindrical member. The firehose sling 1010 includes a retainer 1014 and a sling 1018 stored within the sling 1014 and extendable therefrom. A user firmly grasps a portion of the sling 1018 and pulls with a force to extend the sling 1018 from the retainer 1018. The retainer 1014 remains attached to the segment of firehose while one end of the sling 1018 remains attached to the retainer 1014 and an opposite end of the sling 1018 creates a loop through which the user can insert his/her arm and shoulder. This creates the means by which the user can drag a heavy firehose.

Now referring to FIGS. 27-37, the retainer 1018 has a unibody construction. It can be formed from a single swatch of a woven fabric and is configured to wrap circumferentially about a tubular-shaped firehose 200. The retainer comprises a main body 1022 and a tongue portion 1026.

The main body 1022 has a rectangular shape and a top surface 1030 and a bottom surface 1034. It comprises a pocket 1038, a flap 1040 which closes the pocket 1038, and an aperture 1042 through which the sling 1018 is accessible.

The pocket 1038 is formed by folding a first portion 1043 of the main body 1022 over a second portion 1044 of the main portion. These portions are maintained in position by fasteners. One type of fastener that is particularly useful is the hook and loop fastener. Hook and loop fasteners 1046 are generally the preferred fastener for connecting the various elements of the retainer 1014 and the sling 1018; however, one of ordinary skill would understand that other fasteners could be used as a simple substitution to perform the function of holding two elements together. A first hook and loop fastener 1046 sewn to an edge of the top surface 30 of the main body 1022 is brought into engagement with a second hook and loop fastener 46 sewn to the top surface 1030 of the main body 1022. By this folding, the pocket 1038 is created.

The flap 1040 is formed by further folding of a third portion 1050 of the main body 1022 over the pocket 1038 to close the pocket 1038. Another hook and loop fastener 1046 is sewn to the edge of the top surface 1030 and is brought into engagement with a hook and loop fastener 1046 on the bottom surface 1034 of the first portion of the main body 1022. This closes the pocket 1038 with the flap 1040 and retains the elements in desired position.

The aperture 1042 takes a slotted form. It is located between the second portion 1044 of the main body 1022 and the third portion 1050 of the main body 1022.

A tongue 1054 extends outwardly from a side of the rectangular main body 1022 and parallel to a length of the aperture 1042. The tongue 1054 has a substantially rectangular shape and is integral with and extends outwardly from the main body 1022. The tongue 1054 has a length about equal to a length of a first side of the main body 1022 which is substantially parallel to the tongue 1054. The tongue 1054 intersects a second side of the main body 1022 which is transverse to the first side and shares a portion of the second side. The tongue 1054 comprises a top surface 1058 and a bottom surface 1062.

The top surface 1058 of the tongue 1054 is conterminous with (i.e. shares a boundary with) the top surface 1030 of the main body 1022. The top surface 1058 has a nonslip surface which is configured to engage an outer skin of a tubular-shaped firehose 200 when the retainer 1014 is wrapped circumferentially about a firehose 200.

The bottom surface 1062 of the tongue 1054 is conterminous with the bottom surface 1034 of the main body 1022. The bottom surface has a hook and loop fastener 1046 sewn thereon. The hook and loop fastener 1046 is configured to fasten to a complimentary hook and loop fastener 1046 on the bottom side 1034 of the main body 1022.

The sling 1018 is extendable from the pocket 1038 in the retainer 1014 and preferably has U-shape. The sling 1018 has a pair of ends 1066 each sewn to the top surface 1030 of the main body 1022 within the pocket 1038.

An intermediate section of the sling 1018 comprises a pair of sets of accordion folds 1070 beginning at each of the pair of ends 1066 and moving outwardly towards a center portion 1074 of the sling 1018.

The center portion 1074 has a hook and loop fastener 1046 which is provided to attach to a hook and loop fastener 1046 on the top surface 1030 of the main body 1022 on the flap 1040 adjacent the aperture 1042. A folding of the third portion 1050 of the main body 1022 to produce the flap 1040 causes the center portion 1074 to reside within the aperture 1042 and to be visible on the bottom surface 1034 of the main body 1022 through the aperture 1042. The pair of sets of accordion folds 1070 is stored within the pocket 1038. A color-alert 1078 attached to the center portion 1074 is visible through the aperture 1042.

A pull tab 1082 is attached to the center portion 1054, preferably by sewing. The pull tab 1082 extends outwardly from the aperture 1042 in the main body 1022.

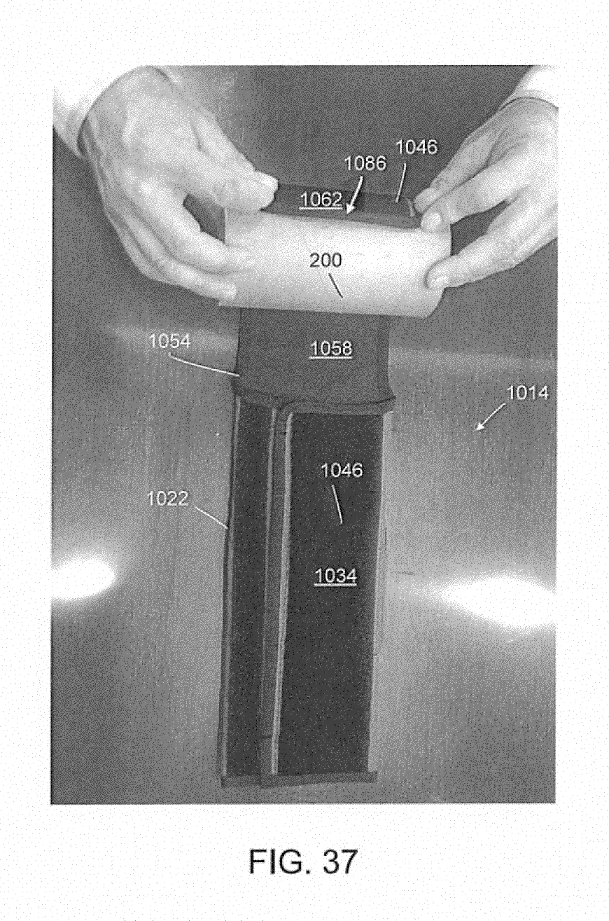

Referring to FIG. 37, the firehose sling 1010 is configured to wrap around and attach to a segment of firehose 200 by placing the segment of firehose 200 against the non-slip top surface 1058 of the tongue 1054 at a terminal end 1086 of the tongue 1054 opposite a connection of the tongue 1054 with the main body 1022. The tongue 1054 is wrapped about a circumference of the segment of firehose 200 to cause the hook and loop fastener 1046 on the bottom surface 1062 of the tongue 1054 to engage the hook and loop fastener 1046 on the bottom surface 1034 of the main body 1022.

As shown in FIGS. 27-29, the firehose sling 200 forms a circumferential sleeve on the segment of firehose 200 with the slot-like form of the aperture 1042 located at a first end 1090 of the circumferential sleeve oriented transverse to a length of the segment of firehose 200. The pull tab 1082 extends from the aperture 1042 parallel to the length of the segment of firehose 200 and against the circumferential sleeve from the first end 1090 of the circumferential sleeve towards a second end 1094 of the circumferential sleeve which is opposite the first end 1090 of the circumferential sleeve.

### Alternative Embodiments of the Extendable Firehose Sling

A firehose sling comprising:

a sling retainer configured to attach to a tubular-shaped firehose;

a sling attached to the sling retainer and extendable therefrom.

A firehose sling wherein the sling retainer comprises a circumferential form.

A firehose sling wherein the sling retainer comprises a pocket, and the sling is stored within the pocket.

A firehose sling wherein the sling retainer comprises an aperture in communication with the pocket, and the sling is extendable from the pocket through the aperture.

A firehose sling wherein the sling comprises a tab extending from the slot when the sling.

A firehose sling wherein a flap closes the pocket.

A firehose sling wherein the aperture has a slotted shape.

A firehose sling wherein the sling is U-shaped and ends of the sling are attached to the sling retainer.

A firehose sling wherein the sling retainer has a non-slip surface configured to engage an outer wall of a tubular-shaped firehose.

A firehose sling wherein the sling retainer is of a unibody construction.

A firehose sling of any preceding embodiment wherein the sling has a retracted condition wherein the sling is retained to the sling retainer and an extended condition wherein a first portion of the sling is selectively extended from the sling retainer and a second portion remains attached to the sling retainer.

A firehose sling of any preceding embodiment wherein the sling retainer is configured to wrap around and attach to a segment of firehose by placing the segment of firehose against a first end of the sling retainer and wrapping the ling retainer about a circumference of the segment of firehose toward a second end of the segment of firehose.

A firehose sling of any preceding embodiment wherein the firehose sling forms a circumferential sleeve on the segment of firehose with a slotted aperture located at a first end of the circumferential sleeve oriented transverse to a length of the segment of firehose.

A firehose sling of any preceding embodiment wherein a portion of the sling extends from the slotted aperture parallel to the length of the segment of firehose against the circumferential sleeve from the first end of the circumferential sleeve towards a second end of the circumferential sleeve opposite the first end of the circumferential sleeve.

A firehose sling wherein the sling retainer comprises:

a main body having a top surface and a bottom surface and comprising a pocket formed by folding a first portion of the main body over a second portion of the main portion and fastening the first portion to the top surface of the main body.

A firehose sling wherein the sling retainer further comprises:

a flap formed by a folding of a third portion of the main body over the pocket to close the pocket.

A firehose sling wherein the sling retainer further comprises:

a slotted aperture located between the second portion of the main body and the third portion of the main body.

A firehose sling wherein the sling retainer further comprises:

a tongue parallel to a length of the slotted aperture extending outwardly from the main body, the tongue intersecting an edge of the main body, the tongue comprising a top surface conterminous with the top surface of the main body and a bottom surface conterminous with the bottom surface of the main body.

A firehose sling wherein the sling comprises:

an intermediate section comprising a pair of sets of accordion folds stored within the pocket.

A firehose sling wherein the sling comprises:

a pull tab extending outwardly from the slotted aperture in the main body.

A firehose sling wherein the sling retainer is configured to wrap around and attach to a segment of firehose by placing the segment of firehose against a non-slip surface at a terminal end of the tongue opposite a connection of the tongue with the main body and wrapping the tongue about a circumference of the segment of firehose.

A firehose sling wherein the sling retainer forms a circumferential sleeve on the segment of firehose with the slotted aperture located at a first end of the circumferential sleeve oriented transverse to a length of the segment of firehose.

A firehose sling wherein the tab extends from the slotted aperture parallel to the length of the segment of firehose against the circumferential sleeve.

A firehose sling wherein the tab extends from the first end of the circumferential sleeve towards a second end of the circumferential sleeve opposite the first end of the circumferential sleeve.

A firehose sling comprising:

a unibody sling retainer formed from a swatch of a woven fabric and configured to wrap circumferentially about a tubular-shaped firehose comprising:
a main body having a rectangular shape and a top surface and a bottom surface and comprising:
   a pocket formed by folding a first portion of the main body over a second portion of the main portion and maintained in position by a first hook and loop fastener sewn to an edge of the top surface of the main body in engagement with a second hook and loop fastener sewn to the top surface of the main body;
   a flap formed by a folding of a third portion of the main body over the pocket to close the pocket by a third hook and loop fastener sewn to the edge of the top surface in engagement with a fourth hook and loop fastener on the bottom surface of the first portion of the main body; and
   a slotted aperture located between the second portion of the main body and the third portion of the main body;
a tongue parallel to a length of the slotted aperture having a substantially rectangular shape integral with and extending outwardly from the main body having a length substantially equal to a length of a first side of the main body substantially parallel to the tongue, the tongue intersecting a second side of the main body transverse to the first side and sharing a portion of the second side, the tongue comprising:
   a top surface conterminous with the top surface of the main body and having a nonslip surface configured to engage an outer skin of a tubular-shaped firehose when the sling retainer is wrapped circumferentially about a firehose;
   a bottom surface conterminous with the bottom surface of the main body, the bottom surface having a fifth hook and loop fastener sewn thereon configured to fasten to a complimentary sixth hook and loop fastener on the bottom side of the main body; and

a sling extendable from the pocket in the sling retainer having U-shape and comprising:
a pair of ends each sewn to the top surface of the main body within the pocket;
an intermediate section comprising a pair of sets of accordion folds beginning at each of the pair of ends and moving outwardly towards a center portion of the sling, the center portion having a seventh hook and loop fastener attaching it to an eighth hook and loop fastener on the top surface of the main body on the flap adjacent the slotted aperture such that the folding of the third portion of the main body to produce the flap causes the center portion having a color-alert attached thereto to reside within the slotted aperture and to be visible on the bottom surface of the main body through the slotted aperture, and the pair of sets of accordion folds is stored within the pocket; and
a pull tab sewn to the center portion and extending outwardly from the slotted aperture in the main body with the center portion,

wherein the firehose sling is configured to wrap around and attach to a segment of firehose by placing the segment of firehose against the non-slip surface at a terminal end of the tongue opposite a connection of the tongue with the main body and wrapping the tongue about a circumference of the segment of firehose to cause the fifth hook and loop fastener on the bottom surface of the tongue to engage the sixth hook and loop fastener on the bottom surface of the main body,

wherein the firehose sling forms a circumferential sleeve on the segment of firehose with the slotted aperture located at a first end of the circumferential sleeve oriented transverse to a length of the segment of firehose, and

wherein the tab extends from the slotted aperture parallel to the length of the segment of firehose against the circumferential sleeve from the first end of the circumferential sleeve towards a second end of the circumferential sleeve opposite the first end of the circumferential sleeve.

While the specific embodiments have been illustrated and described, numerous modifications come to mind without significantly departing from the spirit of the invention, and the scope of protection is only limited by the scope of the accompanying Claims.

What is claimed is:

1. A fire rescue mat apparatus comprising:
an outer skin of flexible material;
linear fold lines defining a plurality of zones arranged in columns and rows, wherein the fire rescue mat apparatus can be folded along the fold lines to reduce an overall size of the fire rescue mat apparatus; and
a plurality of support members located within the zones.

2. The fire rescue mat apparatus of claim 1 wherein the support members are fixedly attached to an upper surface of the outer skin.

3. The fire rescue mat apparatus of claim 2 wherein the flexible material is chosen from a group consisting of a high-density polyethylene, a meta aramid, a cotton, a wool, a fiberglass, and a para-aramid.

4. The fire rescue mat apparatus of claim 3 wherein a pair of adjacent center columns comprises four rows of equal-sized rectangular zones.

5. The fire rescue mat apparatus of claim 4 wherein wing columns are located on opposing sides of the adjacent center columns such that the adjacent center columns are located between the wing columns.

6. The fire rescue mat apparatus of claim 5 wherein each wing column comprises a pair of rectangular zones having a size substantially equal to the equal-sized zones of the adjacent center column

7. The fire rescue mat apparatus of claim 6 wherein smaller zones having a right trapezoidal shape are located on opposing sides of the pair of rectangular zones.

8. The fire rescue mat apparatus of claim 7 wherein the right trapezoidal zones are located at corners of the rescue apparatus.

9. The fire rescue mat apparatus of claim 8 wherein the fire rescue mat apparatus has an octagonal shape.

10. The fire rescue mat apparatus of claim 9 wherein a pair of first parallel edges is separated from a pair of parallel second edges by angled edges formed by the right trapezoidal zones.

11. The fire rescue mat apparatus of claim 10 wherein the plurality of support members comprises twelve equal-sized plates located within twelve rectangular zones formed by the outer skin and four equal-sized smaller plates located within the right trapezoidal zones formed by the outer skin, the twelve-equal-sized plates and the four equal-sized small plates have a rectangular shape.

12. The fire rescue mat apparatus of claim 11 wherein each fold line comprises a seam delimiting each zone.

13. The fire rescue mat apparatus of claim 12 wherein the seam is formed by joining opposite edges of the outer skin of each zone together by an attachment.

14. The fire rescue mat apparatus of claim 13 wherein the attachment is chosen from the group consisting of sewing, welding, hook and loop, rings, and spiral binding.

15. The fire rescue mat apparatus of claim 14 further comprising handles formed along opposing lengthwise sides of the rescue apparatus formed by apertures in the wing columns;

16. The fire rescue mat apparatus of claim 15 further comprising strapping attached to the outer skin for securing a victim to the rescue apparatus.

17. The fire rescue mat apparatus of claim 16 further comprising a lifting ring along one of a side of the rescue apparatus and attached to the outer skin.

18. The fire rescue mat apparatus of claim 17 further comprising a retainer attachable to the rescue apparatus when in the fully folded condition configured to maintain the rescue apparatus in the fully folded condition.

19. A fire rescue mat apparatus comprising:
an outer skin of flexible material forming a plurality of pockets arranged in columns and rows;
a plurality of support members located within the pockets;
linear fold lines separating each pocket from an adjacent pocket, wherein the fire rescue mat apparatus can be folded along the fold lines to reduce an overall size of the fire rescue mat apparatus.

20. A fire rescue mat apparatus comprising:
an outer skin of flexible material chosen from a group consisting of a high-density polyethylene, a meta aramid, a cotton, a wool, a fiberglass, and a para-aramid, the outer skin forming a plurality of pockets arranged in columns and rows, a pair of adjacent center columns comprises four rows of equal-sized rectangular pockets, wing columns are located on opposing sides of the adjacent center columns such that the adjacent center columns are located between the wing columns, each wing column comprises a pair of rectangular pockets having a size substantially equal to the equal-sized pockets of the adjacent center column, smaller pockets having a right trapezoidal shape are located on opposing sides of the pair of rectangular pockets, wherein the right trapezoidal pockets are located at corners of the rescue apparatus, wherein the fire rescue mat apparatus has an octagonal shape, wherein a pair of first parallel edges is separated from a pair of parallel second edges by an angled edges formed by the right trapezoidal pockets, wherein a length of the outer skin is greater than a width of the outer skin.
a plurality of support members located within the pockets, the support members are at least semi-rigid, the support members are produced from a polymeric material, the plurality of support members comprises twelve equal-sized plates located within twelve rectangular pockets formed by the outer skin and four equal-sized smaller plates located within the right trapezoidal pockets formed by the outer skin, the twelve-equal-sized plates and the four equal-sized small plates have a rectangular shape;
linear fold lines separating each pocket from and adjacent pocket, wherein the fire rescue mat apparatus can be folded along the fold lines to reduce an overall size of the fire rescue mat apparatus, each fold line comprising a seam delimiting each pocket, the seam formed by joining opposite surfaces of the outer skin together by an attachment chosen from the group consisting of sewing, welding, hook and loop, rings, and spiral binding, wherein the fire rescue mat apparatus fits within a standard thigh pocket of a standard pair of turnout pants;
handles formed along opposing lengthwise sides of the rescue apparatus formed by apertures in the wing columns;
strapping attached to the outer skin for securing a victim to the rescue apparatus;
a lifting ring along one of the sides of the rescue apparatus and attached to the outer skin;
a retainer attachable to the rescue apparatus when in the fully folded condition configured to maintain the rescue apparatus in the fully folded condition;
wherein the outer skin forms a mat in a fully unfolded condition on which a victim can be positioned and attached thereto by the strapping,
wherein the outer skin has an engagement surface comprising a friction reducing material,
wherein the fire rescue mat apparatus qualifies as a Class 2 rescue harness,
wherein at least some of the pockets have a fluid-tight seal and wherein the at least some of the pockets can be inflated,
wherein the wing columns can be wrapped around a victim to form a protective shield substantially about a torso of the victim by tightening the strapping.
